(19) United States
(12) Patent Application Publication
(10) Pub. No.: US 2013/0186983 A1
(43) Pub. Date: Jul. 25, 2013

(54) Water nozzle with a notched deflector

(71) Applicant: BELEGGINGSMAATSCHAPPIJ NOVENTU B.V., Ba Delft (NL)

(72) Inventor: Andres Chamorro Canet, Barcelona (ES)

(73) Assignee: BELEGGINGSMAATSCHAPPIJ NOVENTU B.V., Ba Delft (NL)

(21) Appl. No.: 13/747,810

(22) Filed: Jan. 23, 2013

(30) Foreign Application Priority Data
Jan. 24, 2012 (ES) U201230073

(51) Int. Cl. B05B 1/12

(52) U.S. Cl. CPC B05B 1/12
USPC 239/455

(57) ABSTRACT

A water nozzle includes an outer cylindrical body and a laminator cylinder, axially movable over an exterior of the cylindrical body. A notched deflector is axially positioned inside the cylindrical body, the deflector being provided with a series of notches peripherally positioned over a lateral cylindrical face of a head of the deflector.

### CROSS-REFERENCE TO A RELATED APPLICATION

The invention described and claimed hereinbelow is also described in Spanish Patent Application U201230073, filed on Jan. 24, 2012. This Spanish Patent Application, subject matter of which is incorporated herein by reference, provides the basis for a claim of priority of invention under 35 U.S.C. 119(a)-(d).

### BACKGROUND OF THE INVENTION

The present invention relates to a water nozzle, attachable to the end of a fire hose, monitors and/or the like, characterized in that it is provided with a notched deflector to deflect the water stream and the immediate lamination or direction of the multiple water streams through the laminator cylinder of the nozzle, the essential characteristics of the invention being described below.

The water stream that comes through the nozzle, also known in the state of the art as spout, attached to the end of a hose or a monitor, generally in a fire station, is aimed not only at extinguishing the fire by pumping a stream of water or fog directly over the fire or its surroundings in cooling and/or protection activities, but also at creating, on a certain moment and at the will of the specialized staff using the nozzle, a protective screen for the staff itself, formed by water fog that will come out of the nozzle and that will be created thanks to the characteristics of the internal components of the aforementioned nozzle.

### SUMMARY OF THE INVENTION

The object of the invention is to provide the nozzle with a basic element, such as the deflector, located at the front and inside the nozzle, which is provided with a number of notches made in its inner peripheral edge with pre-established slopes and dimensions to allow deflecting the water stream in multiple streams which are immediately laminated or dissected by the laminator cylinder located in the outer upper part of the nozzle.

The necessary and needed fog, when operating in areas exposed to considerable high temperatures and to prevent injuries to the operating specialists, is created by a process derived from the special and characteristic placement of the deflector and laminator cylinder that the nozzle features.

As the different streams, resulting from the deflection of the main stream, intersect when going through the deflector, and as the laminator cylinder is manually moved backwards, the creation of fog starts when the aforementioned notches of the deflector emerge outside the deflector, from this moment the compact stream is gradually combed until it disappears and there is a full cone of water, formed by thin water drops, with a fog angle of approximately 30°.

As the laminator keeps moving backwards, the fog cone, still of a notable thickness, starts spreading until it forms a protective screen.

Currently, the deflectors used in water stream nozzles have conventional systems of rotating or fixed teeth, which protrude over the upper face of the deflector, with which a cone of fine water drops, driven at a lower speed than the drops constituting the curie formed by the deflector of the nozzle object of the present invention, is obtained.

The speed of the fine water drops is higher since they result from the different water streams originally formed and its formation is not established by the impact against external projections or teeth.

Essentially, the nozzle according to the present invention has a deflector without external teeth or projections, either fixed or rotating, being substituted by a set of peripheral notches already mentioned above. This novelty embodiment considerably reduces maintenance as well as the risk of damage to the external teeth or projections, since it doesn't have any.

The especial arrangement of the peripheral notches allows providing the water drops with a higher exit speed, therefore generating a more efficient fog both in the quality of the water drop and the density of the water cone.

### BRIEF DESCRIPTION OF THE DRAWINGS

In order to complement the description of the water nozzle object of this invention, a set of drawings is attached, where, with an illustrative, non-limiting character, the novelty part of the nozzle, with its notched deflector and its laminator cylinder, has been represented. In the drawings,

FIG. 1 is a representation, in a dihedral projection, of the notched deflector, with a semi-sectioned elevational view and a plan view; and

FIG. 2 is a perspective view on a smaller scale of the nozzle, partially sectioned in its outer part to show the arrangement of the notched deflector and the laminator cylinder, being this in its initial stream position.

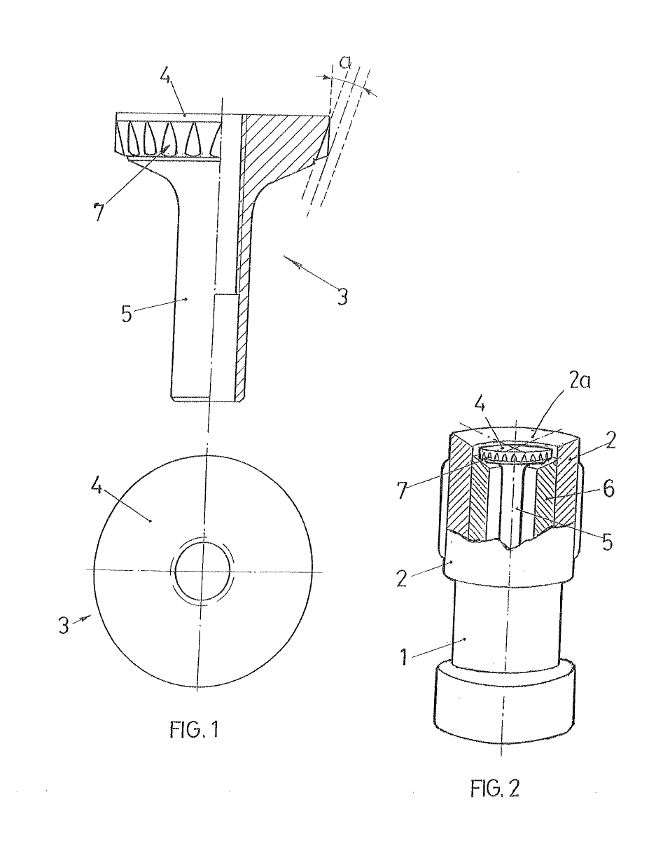

### DETAILED DESCRIPTION OF THE PREFERRED EMBODIMENTS

According to the figures, the water nozzle essentially consists of an outer cylindrical body 1 over which a laminator cylinder 2 with an upper base 2a slightly troncoconical and innerly sloped, is axially moved.

The notched deflector 3 is axially positioned inside the body 1, all its head 4, with a flat and horizontal upper face, remaining next to the upper mouth or aperture of the laminator cylinder 2, while its cylindrical tail 5 is surrounded by an inner cylinder 6.

An essential characteristic of the notched deflector 3 is that it is provided, on the lateral cylindrical face of its head 4, with a peripheral series of notches 7, in a variable number and angle “a” depending on the type of nozzle or the desired water drop size.

The axial movement of the laminator cylinder 2 downwards, allows the head 4 of the notched deflector 3 to protrude more or less, depending on the preference, above the upper base 2a of the laminator cylinder 2, the aforementioned notches 7 remaining sufficiently and necessarily exposed so that the lamination of the water stream and the resulting formation of fog, occurs.

It will be understood that each of the elements described above, or two or more together, may also find a useful application in other types of constructions differing from the types described above.

While the invention has been illustrated and described as a water nozzle with a notched deflector, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A water nozzle, comprising:
an outer cylindrical body and a laminator cylinder, axially movable over an exterior of the cylindrical body; and
a notched deflector axially positioned inside the cylindrical body, wherein the deflector is provided with a series of notches peripherally positioned over a lateral cylindrical face of a head of the deflector.

2. The water nozzle according to claim 1, wherein the notches are uniformly arranged and in a variable number depending on the water drop selected.

3. The water nozzle according to claim 1, wherein the notches are oriented in a characteristic angle depending on a difference in diameter between the deflector and the laminator cylinder.
